(19) United States
(12) Patent Application Publication
(10) Pub. No.: US 2025/0328972 A1
(43) Pub. Date: Oct. 23, 2025

(54) Apparatus and Method for Supplying Real-time Residential Real Estate Analytics with Dynamic Market Indicies

(71) Applicant: Lamda, Inc., Bellevue, WA (US)

(72) Inventors: Brian LENT, Bellevue, WA (US); David BLUHM, Bellevue, WA (US); Neal OMAN, Bellevue, WA (US); Vincent O'NEILL, Bellevue, WA (US); Daniel WHITE, Bellevue, WA (US); Karl KNAUB, Bellevue, WA (US); William BRADLEY, Bellevue, WA (US); Michael SHAPIRO, Bellevue, WA (US)

(21) Appl. No.: 18/054,403

(22) Filed: Nov. 10, 2022

Related U.S. Application Data
(60) Provisional application No. 63/277,978, filed on Nov. 10, 2021.

(51) Int. Cl. G06Q 50/16; G06N 3/08

(52) U.S. Cl. CPC G06Q 50/163; G06N 3/08

(57) ABSTRACT

A computer implemented method includes collecting multi-modal residential real estate data from networked machines. The multi-modal residential real estate data is segregated into relational data, textual data and image data to form segregated data. Statistical anomalies in the segregated data are corrected to form first refined data. The first refined data is augmented to reduce sparsity and form second refined data. Numerical embedding vectors are computed from the second refined data. The numerical embedding vectors are aggregated by geographic region. A deep neural network is trained using the numerical embedding vectors to form models for predicting residential real estate attributes. The models are utilized to compute a dynamic value for a specified residential real estate asset. Parcels in a geographic area surrounding the specified residential real estate asset are defined. The models compute dynamic values for the parcels in the geographic area. Analytics for the parcels in the geographic area are computed.

### CROSS-REFERENCE TO RELATED APPLICATION

This application claims priority to U.S. Provisional Patent Application Ser. No. 63/277,978, filed Nov. 10, 2021, the contents of which are incorporated herein by reference.

### FIELD OF THE INVENTION

This invention relates generally to machine-to-machine interactions in a computer network. More particularly, this invention is directed toward techniques for supplying real time residential real estate analytics with dynamic market indices.

### BACKGROUND OF THE INVENTION

Purchasers and owners of residential real estate have disjointed sources of information about any given piece of property. It would be desirable to integrate information sources to supply dynamic residential real estate analytics at a parcel level and geographical regional levels.

### SUMMARY OF THE INVENTION

A computer implemented method includes collecting multi-modal residential real estate data from networked machines. The multi-modal residential real estate data is segregated into relational data, textual data and image data to form segregated data. Statistical anomalies in the segregated data are corrected to form first refined data. The first refined data is augmented to reduce sparsity and form second refined data. Numerical embedding vectors are computed from the second refined data. The numerical embedding vectors are aggregated by geographic region. A deep neural network is trained using the numerical embedding vectors to form models for predicting residential real estate attributes. The models are utilized to compute a dynamic value for a specified residential real estate asset. Parcels in a geographic area surrounding the specified residential real estate asset are defined. The models compute dynamic values for the parcels in the geographic area. Analytics for the parcels in the geographic area are computed.

### BRIEF DESCRIPTION OF THE FIGURES

The invention is more fully appreciated in connection with the following detailed description taken in conjunction with the accompanying drawings, in which:

FIG. 1 illustrates a computer network configured in accordance with an embodiment of the invention.

FIG. 2 illustrates operations performed by a data aggregator utilized in accordance with an embodiment of the invention.

FIG. 3 illustrates operations performed by a machine learning training module utilized in accordance with an embodiment of the invention.

FIG. 4 illustrates data sources, a data store, an indexing engine and an analytics module utilized in accordance with an embodiment of the invention.

FIG. 5 illustrates dynamic valuation operations performed in accordance with an embodiment of the invention.

FIG. 6 illustrates an interface for a user to characterize a property for home condition analyses.

FIG. 7 illustrates an interface for a user to upload residential photos for home condition analyses.

FIG. 8 illustrates an interface for displaying output of a dynamic valuation process.

FIG. 9 illustrates processing operations associated with the remodel module.

FIG. 10 illustrates remodel graphical user interfaces utilized in accordance with an embodiment of the invention.

FIG. 11 illustrates an index engine utilized in accordance with an embodiment of the invention.

FIG. 12 illustrates index engine mean price output generated in accordance with an embodiment of the invention.

FIG. 13 illustrates index engine superimposed graphical output generated in accordance with an embodiment of the invention.

FIG. 14 illustrates a neighborhood defined by the index engine in accordance with an embodiment of the invention.

FIG. 15 illustrates a mean price index for the neighborhood of FIG. 14.

FIG. 16 illustrates a dollar per square foot metric formed by the index engine.

FIG. 17 illustrates a positive correlation formed by the index engine.

FIG. 18 illustrates a dynamic residential real estate aggregate visualization utilized in accordance with an embodiment of the invention.

FIG. 19 illustrates a dynamic residential real estate aggregate visualization illustrating trends across states.

FIG. 20 illustrates a dynamic residential real estate aggregate visualization illustrating trends on a per state basis.

FIG. 21 illustrates a dynamic residential real estate aggregate visualization illustrating trends in a geographic region.

FIG. 22 illustrates a dynamic residential real estate aggregate visualization illustrating trends on a per county basis.

FIG. 23 illustrates a dynamic residential real estate aggregate visualization illustrating gradient trends in a geographic region.

FIG. 24 illustrates a dynamic residential real estate aggregate visualization illustrating trends on a per neighborhood basis.

FIG. 25 illustrates information on particular properties selected by a user in two different geographic locations.

Like reference numerals refer to corresponding parts throughout the several views of the drawings.

### DETAILED DESCRIPTION OF THE INVENTION

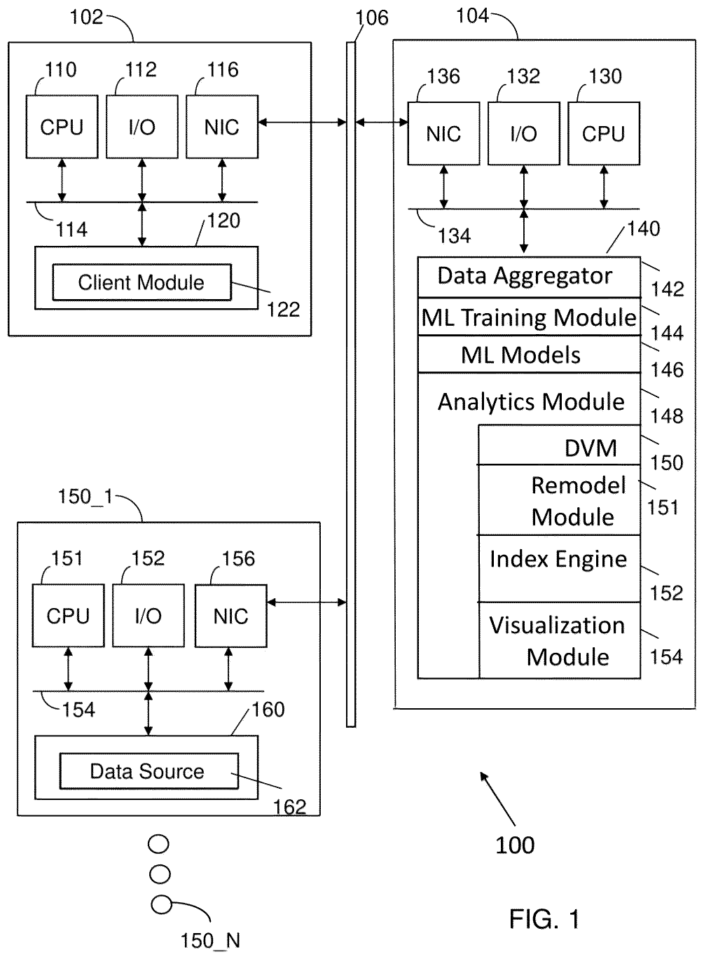

FIG. 1 illustrates a system 100 configured in accordance with an embodiment of the invention. The system 100 includes a client device 102 in communication with a server 104 via a network 106, which may be any combination of wired and wireless computer networks. Client device 102 may be a computer, tablet, smartphone, wearable device and the like. Client device 102 includes a processor 110 connected to input and output devices 112 via a bus 114. The input and output devices may include a keyboard, touch display, mouse and the like. A network interface circuit 116 is also connected to the bus 114 to provide connectivity to network 106. A memory 120 is also connected to the bus 114. The memory 120 store a client module 122 with instructions executed by processor 110. The client module 122 is used to display data received from server 104 relating to residential real estate analytics, as shown in subsequent figures.

Server 104 includes a processor 130, input and output devices 132, a bus 134 and a network interface circuit 136. A memory 140 is connected to bus 134. The memory 140 stores instructions executed by processor 130 to implement residential real estate analytics operations disclosed herein. The executable instructions include a data aggregator 142. The data aggregator 142 collects information from disparate network resources to produce a data lake that is utilized to provide analytics, as detailed below. The memory 140 also stores a machine learning (ML) training module 144, which has executable instructions to process data from the data aggregator 142 to train a collection of ML models, as detailed below. This results in a ML models 146, which are stored in memory 140. An analytics module 148 includes instructions executed by processor 130 to utilize the ML models to produce residential real estate metrics. The analytics module 148 includes a dynamic valuation module (DVM) 150, which produces a dynamic valuation of a specified residential real estate asset, as detailed below: A remodel module 151 produces remodel suggestions and estimated value enhancements attributable to such remodel suggestions. An index engine 152 produces indices that aggregate residential real estate assets at different geographical levels, as demonstrated below: A visualization module 154 includes instructions executed by processor 130 to render residential real estate visualizations based upon dynamic valuations and geographic areas of different sizes, as demonstrated below. Server 104 is shown as a single computer for purposes of convenience. It should be appreciated that server 104 is implemented as a collection of distributed servers to implement the large-scale data processing operations disclosed herein.

FIG. 1 also illustrates a collection of data source computers 150_1 through 150_N. Each data source computer has a processor 151, input and output devices 152, a bus 154 and a network interface circuit 156. A memory 160 is connected to bus 154. The memory 160 stores a data source 162, which can be accessed by server 104 via network 106. The data source computers 150_1 through 150_N may include national, local and hyper-local data sources, such as automated valuation model (AVM) computers, residential real estate permitting computers, multiple listing service computers, tax assessor computers, and county recorder computers. The computers may also include computers with geocoded and time-series data, such as geo specific data, macro-economic data and micro-economic data.

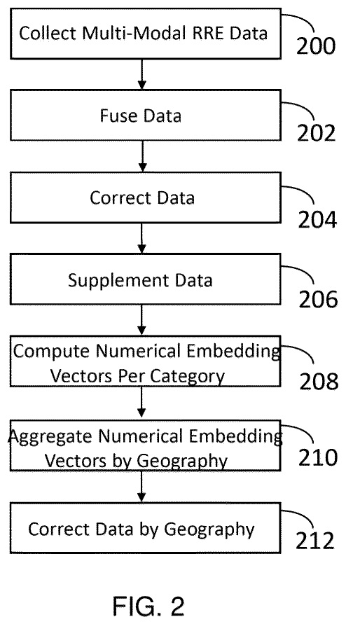

FIG. 2 illustrates processing operations performed by the data aggregator 142. The first operation is to collect multi-modal residential real estate data 200. The data aggregator 142 does this by accessing the data source computers 150_1 through 150_N. The multi-modal residential real estate data includes tabular, free text and image data from multiple public and proprietary sources. These datasets describe: the physical attributes of residential real estate parcels, both land and structures, county assessor records on properties (tabular), Multiple Listing Service (MLS) property records (tabular) and descriptions (free text) of physical condition of the parcel and structures on the parcel, photos (imagery) from MLS sources and user uploads. The data also includes geospatial characteristics of the location, such as local, state, and national government agencies data on noise, air quality, flood risk, etc. Private sector data producers may also be accessed for measures of traffic patterns, walkability, elevation, crime, and the like. Aerial and satellite imagery may also be processed. Fast and slow time-series datasets describing local area historical residential real estate sales transactions may be consumed along with national and local micro- and macro-economy characteristics, and correlated commodity and stock market dynamics.

The collected data is fused 202. That is, data fusion methods are used for blending overlapping data physical characteristic sources to optimize completeness and accuracy. Data is fused by data type. Thus, relational data is fused with other relational data. Textual data is fused with other textual data and image data is fused with other image data. In one embodiment, maximum likelihood methods are used for selecting between inconsistent values from multiple sources. Data fusion methods are also used for combining static parcel physical and geospatial characteristics with fast- and slow-moving time-series data, which affect residential real estate market dynamics. The data fusion operation may be performed at another processing stage, such as after operation 206.

The data set is subsequently corrected 204. Statistical techniques are used to identify implausible residential real estate facts. For example, such outliers may be identified by computing the likelihood of a particular property configuration existing, given the overall distribution of characteristics in the same geography. Anomalous data may be dampened with a weight or substituted with a mean value for a specified geographic region.

Next, the data is supplemented 206. In particular, techniques are used for replacing missing values with analytically estimated values. Missing values can often be approximated based on the characteristics of properties in the same geography. Statistical techniques, (e.g., mean, median, mode) are used for computing replacement values.

The supplemented data may include new characteristics engineered from raw data that assure consistency of representation of property attributes across sources and geographies. For example, across counties different terminology is used to refer to the same feature type, such as asphalt shingles or composite shingles. These values are made consistent across the data schema to assure they are treated equivalently in training the model.

The next operation of FIG. 2 is to compute numerical embedding vectors per residential real estate category 208 (or categorical variable). That is, numerical embedding vectors are used to represent several categorical data elements. This is a technique used in deep learning to create vectorized representations of data otherwise not amenable to numeric representation. For example, properties can have multiple types of view, such as lake, ocean, or mountain. The presence of none, one, or more of these can be represented numerically as a vector of values, where the values are scaled to maximize the explanatory power each view type. In addition to view as a category, embedding vectors may be created for non-categorical house attributes, such lot square footage, dwelling square footage, number of bedrooms, number of bathrooms and the like. Categorical embedding vectors are also based upon processed image data. For example, a photo of a kitchen may be given labels defining the different attributes of the kitchen and the deemed quality of those attributes. The kitchen may then be ascribed a quality value on some numeric scale. Such information is used in several ways as discussed below.

The next operation is to aggregate numerical embedding vectors by geography 210. That is, the data aggregator 142 computes spatiotemporal contextual embeddings to represent parcel sales data in recency and physical location proximity. The value of a subject property is highly influenced by sales transactions that are geographically and temporally close. This relationship can be represented by a vector of numbers, with each scaled to maximize the explanatory power of price, relative to location and time. Vectors may be created by neighborhood, zip code, county, metropolitan statistical area, and state.

The final operation of FIG. 2 is to correct data by geography 212. That is, filtering and outlier processing is performed based upon geospatial and property-type data density. For example, outliers are detected by examining distribution of values in a similar geography to understand which cases are unreasonable. The ingested data can be very sparse and there are cases where only a very small number of properties in a county will have some features populated. Measures are taken so that rare cases do not overly influence model training.

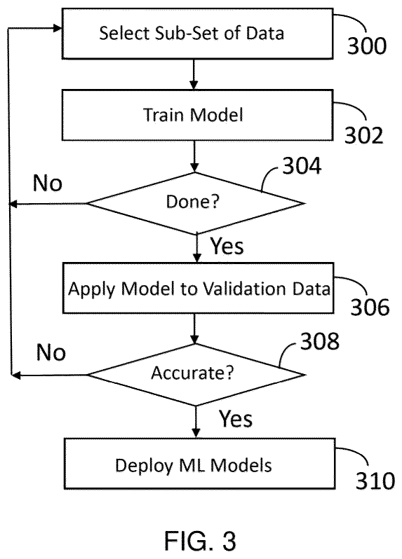

At this point the ingested data is ready for use in training ML models, such as Deep Neural Network (DNN) models. FIG. 3 illustrates operations performed by the ML training module 144. A random sub-set of data is selected 300. The data is split into train and test sets. It is then applied in an iterative loop to train and test the ML model 302. If training is not completed (304—No), meaning the desired accuracy against the test set is not achieved, another sub-set of data is selected 300 and another training and testing process transpires 302. This loop is repeated until the model is trained (304—Yes). The resulting model is applied to validation data 306. That is, the accuracy of the trained Deep Neural Network (DNN) is evaluated by predicting the target variable (e.g., sale price) of records in a held-out validation set of records used in neither the training nor test datasets. If the model is not sufficiently accurate (308—No), processing returns to block 300. If the model is sufficiently accurate (308—Yes), the model is deployed 310. The operations of FIG. 3 are performed for each ML model deployed in the system. Each ML model is trained on data relevant to the ML model. Thus, for example, an ML image processing model is primarily trained on property-level image data.

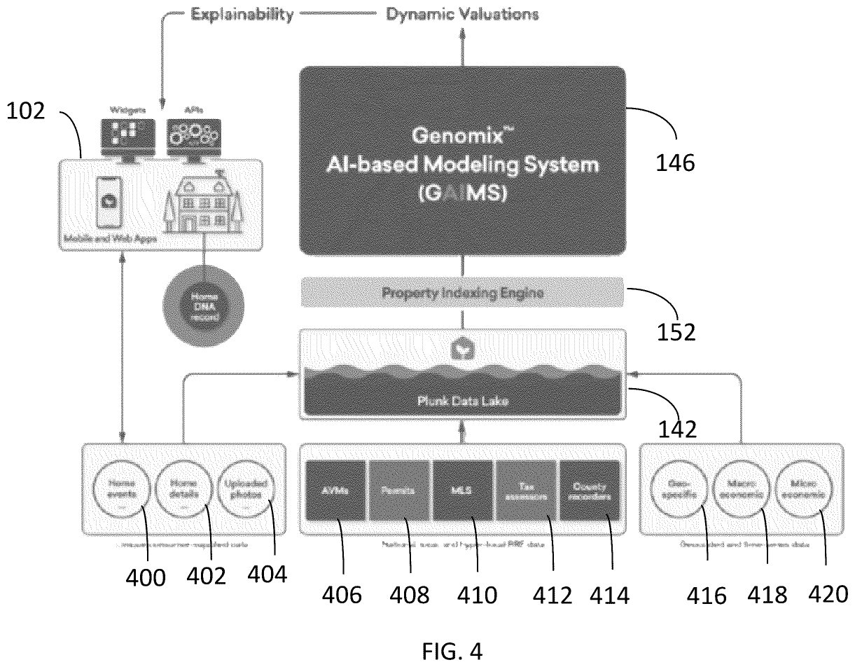

FIG. 4 is an alternate characterization of the elements of FIG. 1. Client device 102 receives analytics based upon the ML models 146, which are referred to here as a Genomix AI-based Modeling System. The figure also illustrates the index engine 152 and a data lake produced by data aggregator 142. The data aggregator 142 collects data from unique consumer-supplied data, including home events 400, home details 402 and uploaded photos 404. National, local and hyper-local data are also collected by the data aggregator 142, including automated third-party valuation model (AVM) data 406, housing permit data 408, multiple listing service data 410, which may include home photographs, tax assessor data 412 and county record data 414. Geocoded and time-series data is also collected by the data aggregator 142, including geo-specific data 416, macro-economic data 418 and micro-economic data 420.

The disclosed technology is a closed-loop machine learning technology platform that is dynamic in that it learns over time by observing new data rows and new data types. It is designed to enable new analytic models to be built on a common repository of normalized, canonicalized data (the data lake) as well as already-trained ML models (also referred to as Artificial Intelligence (AI) and ML models or AI/ML models) that are contained within the Genomix AI-Based Modeling System on which new and different predictive models are built. Importantly, since the system is a closed-loop, as new data sources are added and new data points in time are observed, all the analytic models built are improved in terms of their accuracy and outputs-thereby creating a “virtuous cycle” of a constantly-improving system.

The ability to source and ingest many forms of multi-modal data about a property, the surrounding geography, as well as micro- and macro-economic data is noteworthy. This multi-modal data includes structured data, unstructured data (e.g., free form text descriptions of a property or neighborhood), geo-specific data (e.g., latitude/longitude), images of the inside and outside of a home including satellite imagery, LiDAR data, financial time-series data, and the output of other analytic models-to name a few of the many types of sources of data.

Data sources include: (i) manually provided updates or photos of a home from a homeowner, realtor or other professional: (ii) property-specific information from national, local, and hyper-local residential real estate data sources, and (iii) geo-coded and time-series data.

This information is indexed under a common, globally unique identifier for each property. The disparate information is normalized to a common schema. As previously referenced, the data is analyzed to know if there are features missing that are expected, how to handle outlier data points, and use techniques to improve the overall data quality with techniques such as feature engineering or data imputation.

The system canonicalizes terminology both across the different data sources, but also across regions in the country (e.g., what an assessor's office in a county in California may call a “composite shingle roof”, an assessor in a county in Maryland may call that same roof a “tar roof”).

Data is constantly ingested. The data is either “pulled” by the system or is “pushed” to the system by various external data providers. Part of the system uniqueness is its ability to ingest data of all various types but also of varying update frequencies and quality.

Not all data sources of the same ‘type’ have the same attributes, so data is corrected to produce a consistent set of attributes for each data source type. This involves methods to computationally impute specific missing values (often times using other trained AI/ML models: for instance, to impute the number of bedrooms of a home (based on all the other features of that home) if that data attribute is not otherwise listed or if the value listed is deemed to be erroneous. This step also includes cleansing the data—correcting misspellings, removing whitespace characters, removing stop words in free-form text, etc.

The system attempts to normalize the values of each individual attribute. For instance, for state, some data sources may use two-letter abbreviations and others the full text (e.g., “CA” and “California” or “Calif.”)—these must be standardized into a common data dictionary such as “CA”.

Photos of the interior, exterior, or satellite are many times provided via URL and thus must be retrieved and stored. The photos must also be converted into a standard file format (e.g., JPEG) and sometimes size (e.g., 4 megapixel) for consistent processing by downstream analytics.

Photo condition scoring is a unique and important differentiation of the system. Photos are processed via a separate set of AI/ML models to produce a number of different ‘scores’ that are added as engineered features into the overall data lake. Examples include the condition of the home appropriately scaled to the Uniform Appraisal Code of C1 (Luxury grade) to C6 (Disrepair) and specific features tagged in the photos (e.g., stainless steel appliances, skylights, hardwood floors, cracked foundation, leaking hot water heater, high-end kitchen cabinetry, granite countertops, etc. . . . ). Each photo is turned into a complex vector of values characterizing attributes of the photo. The vectors are fed directly into the system where they are directly mapped to varying desired analytic outcomes (e.g., does this photo improve the valuation of this home?).

Each property is assigned a universal ID. A challenge in the U.S. based residential real estate market is that there is no common, universal way in which to identify a property or different geographic locations. While counties often times use FIPS (county ID) and APN (Assessor Parcel Number), in some counties they choose to recycle these identifiers, and in others they are not always unique. Further, even zip code boundaries sometimes overlap, and neighborhood boundaries may overlap and extend across property parcels and cities and counties. Further, other data is provided via Latitude/Longitude. The system must standardize all of this to point to a single, universal ID of a property if further downstream processing is to be effective. As a secondary step, the system then indexes all of this information so that properties can quickly and consistently be retrieved by the system based on different criteria (e.g., street address, parcel #, latitude/longitude, etc.).

An embodiment of the invention has an AI system for data validation. Even with the data cleansing steps previously referenced, different models in the system may expect certain ‘distributions’ in the attributes of the inputs to that particular model. The system verifies that the distributions are consistent with those the model was trained on. For instance, for a model that predicts the valuation of a home, it may expect a certain “normal distribution” in the square footages of all of the homes it sees in the US. But if for some reason incoming data has an extra zero at the end, the sizes of all US homes based on their square footage would be dramatically different, potentially causing the models to produce erroneous results. This step attempts to check and flag any model input features that are not following known/expected distributions.

An embodiment of the invention uses a proprietary AI/ML development framework. An essential and core component of any sophisticated, closed-loop AI/ML system is the ability to easily build machine learning models, train them, perform some sort of cross-validation to test these models on a subset of the training data, and then measure one or more performance attributes (targets) of the ML model to know that its improving with time and iterations (a common such quality metric, for example, is MAPE (Median Absolute Percent Error rate) and PPE10 (what percent of all data scored by the ML model has an Error rate of 10% or less). These metrics are then stored with the ML models and used in later stages to refine the model as new data sources are ingested or data is improved in this closed-loop system.

An embodiment of the invention uses a proprietary AI/ML model for deployment. One of the most delicate and complex steps in any AI/ML system is how to deploy trained models into a “production” environment. In production, models are compiled into binary executables and operate on the data inputs provided to them. But in the disclosed system, these models must also do all of the data pre-processing noted earlier. The Model Metadata—information about the version of the underlying model, assumptions on data inputs, what databases the model should connect to, timestamp the model was built and other environmental factors also need to remain ‘attached’ to the production model for proper execution and later analysis and debugging purposes.

An embodiment of the invention uses an AI/ML operations model. When an AI/ML model is deployed into production, it must be monitored for performance and response times to the final end-consumer or end-system that is calling the model, and it must also support the appropriate key-type authentication protocols for authorized users. Models in production typically only produce ‘scores’—or outputs—in real-time as the models are called and are not designed (or desired) to retrain and relearn in a production environment.

An embodiment of the invention uses an AI model to provide explanations. AI models endeavor to produce real-time scores with the lowest error rate. As they do so, they most often become completely opaque in how they operate and thus there are no “human interpretable” explanations for why such models produce the values they do. However, in some instances an explanation is highly desired. The disclosed system includes algorithms that provide explanations from DNNs.

The disclosed system includes real-time or batch APIs. This feature is part of the operations and production deployment of the various AL/ML models. Most models require inputs in order to function and use Application Programming Interfaces (APIs) to enable this functionality to external third-party systems. In other instances, the system hosts live-code widgets that provide the programming code plus the direct API access to produce the desired model output (which could be a unique chart or graph). This stage must properly monitor and account for the API usage to attribute to the appropriate external customer for usage and billing purposes.

An embodiment of the invention has AI models to process feedback from customers and systems. A very important and often overlooked step of a true closed-loop, machine learning system is the ability to register how the external world has changed based on the outputs of the ML models. In the area of residential real estate, these are often changes to property data, updated photos, new property features, etc. This behavior drives real-time updates of the source data, which then in turn can trigger new model training. With such external feedback and also with new data elements that change (such as time-series data that could include, for example, real-time stock market performance), the entire process loops to the data ingestion operation.

Reference has been made to the many sources of data that are ingested. A particularly significant form of data is image data. Consumers or professionals take photos of specific rooms inside the home and outside photos that show the exterior state and condition of the property. The system scores for condition quality (on a scale of C1 to C6, following the Uniform Appraisal Code). The system segments images and tags features in the image. This results in image-metadata that is used by the DVM 150 to ascertain how the “quality” of the home is affecting its real-time valuation.

The home condition scoring sub-system supplies a more accurate valuation of a given home, with knowledge of the condition of the home, as represented by photos of the interior and exterior of the home. The user may provide one or more photos of features of a home, including but not limited to rooms, structures, sub-structures, materials or surfaces. Each photo is individually assessed, and a condition score is assigned on a scale. Multiple photos of the same room, structure or feature are aggregated into a combined score for that feature (e.g., a kitchen). An overall condition score for the home is assigned by aggregating the condition scores of each of the home features.

The condition scores along with the vector-representation of the images themselves are used for model training (i.e., the model learns the effects of each condition score on a home's valuation), and for the purposes of scoring (i.e., estimating the value of homes individually or in bulk).

Other aspects of the home condition include entities found within the photos of the home. An example is stainless steel appliances or granite countertops in a kitchen. These entities can be extracted from the provided photos and used as inputs both for training of the model and for scoring of the subject homes.

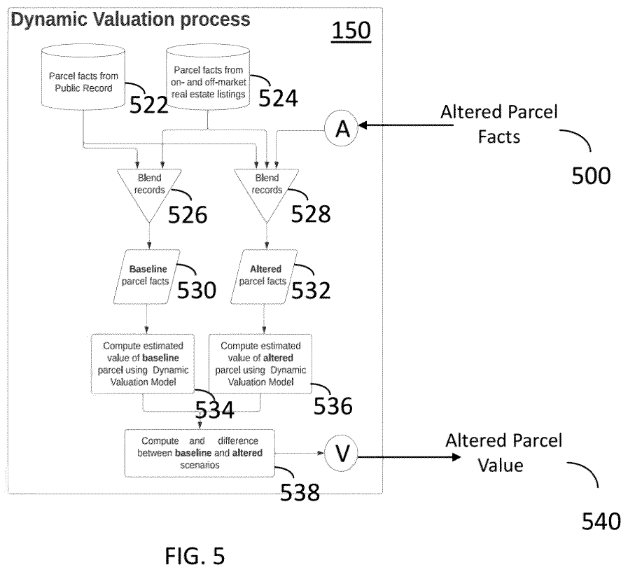

FIG. 5 illustrates processing operations associated with an embodiment of the Dynamic Valuation Module (DVM) 150. The DVM 150 computes a dynamic valuation of a residential real estate asset once the asset is specified (e.g., by providing an address or clicking on an icon representing the asset). The data lake associated with the data aggregator 142 may already have sufficient information on a parcel to provide a dynamic valuation using ML models 146. However, the analytics module 148 allows for altered parcel facts 500 to be considered.

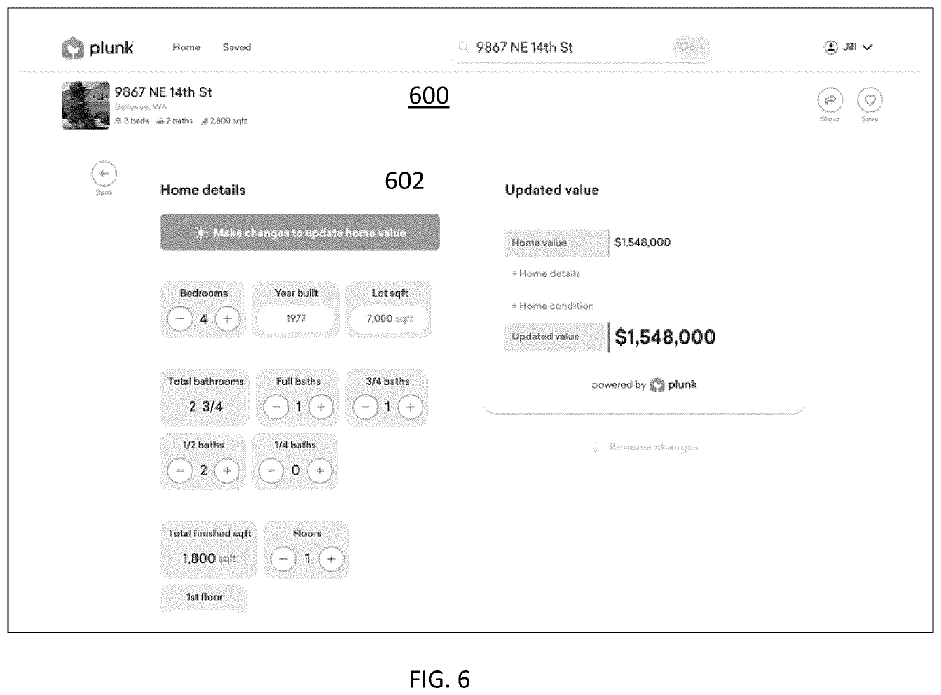

FIG. 6 illustrates an interface 600 with an address specified. A home details block 602 has prompts to specify information, such as number of bathrooms, year built, lot size, number of bedrooms, number of full baths, etc.

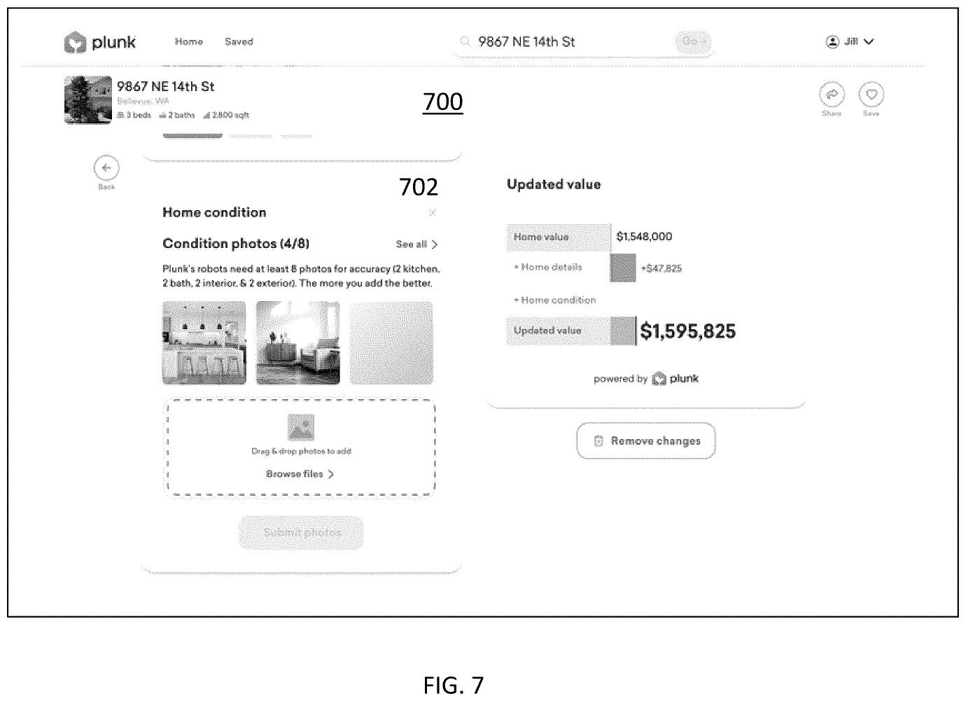

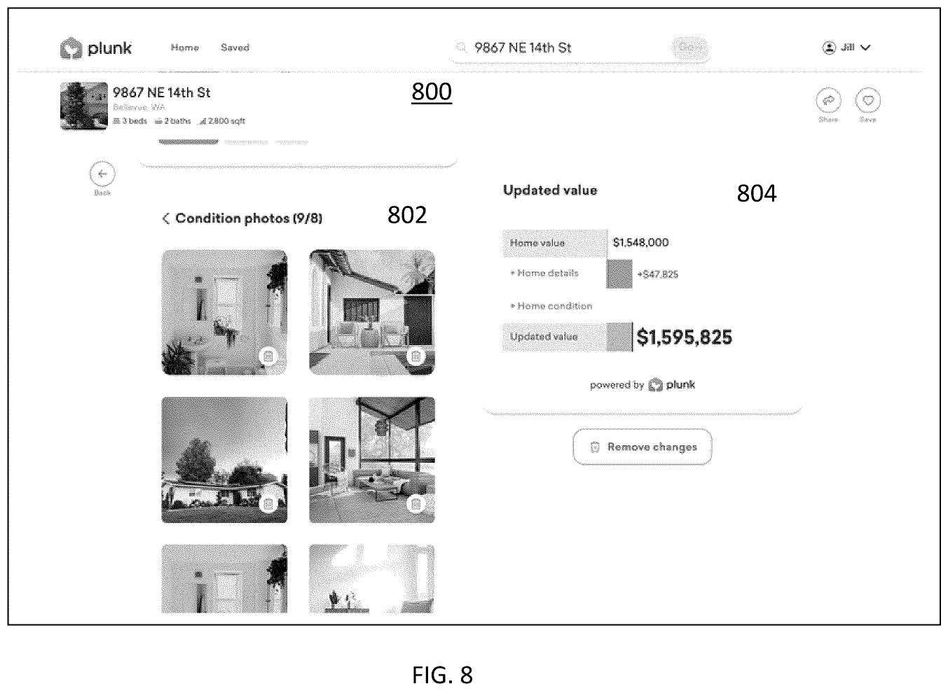

FIG. 7 illustrates an interface 700 with a home condition block 702 that prompts a user to supply photographs of a home for evaluation by the ML models 146. That is, the DVM 150 supplies the interfaces of FIGS. 6 and 7 and then coordinates with the ML models 146 to generate a dynamic value for the residence. The dynamic value may be derived solely from the ML models 146 or the ML model output may be supplemented by rule-based criteria enforced by the DVM 150. The output may be displayed in interface 800 of FIG. 8. Interface 800 illustrates condition photos 802 evaluated by the system in its assessment of the dynamic value. The interface 800 also includes an updated value block 804. Here, the home details collected from interface 600 and the home condition photos collected through interface 700 have resulted in an enhanced valuation.

Returning to the dynamic valuation process of FIG. 5, the previously referenced data lake includes parcel facts from public records 522 and parcel facts from on- and off-market real estate listings. These records are blended 526, 528, as discussed in connection with FIG. 4. Connector A represents an altered set of attributes or altered parcel facts 500. This could be a wholesale replacement of all attributes of a parcel or alterations to specific attributes of a parcel. Rules are applied to blend the parcel attributes from multiple sources into a single, canonical, normalized representation of parcel attributes, invariant of source to produces baseline parcel facts 526. Alterations (A) are applied, overriding specified attributes in this canonical representation of the parcel facts to produce altered parcel facts 532.

Operations 534 and 536 demonstrate that the system scores the baseline and altered permutations from steps 530) and 532 using the dynamic valuation model, resulting in estimated value of each permutation in absolute dollars.

Finally, the system computes the difference between the baseline and altered permutation in both absolute dollars and as a percent change 538. This is computed in reference to the baseline, such that a positive change represents an increase to the baseline, and a negative change represents a decrease to the baseline. This results in an altered parcel value 540, which may be displayed in interface 800 of FIG. 8.

The remodel module 151 computes remodel options that may be adopted to enhance the valuation of the property. For any given piece of property, the remodel module 151 computes remodel project scenarios 900. More particularly, the remodel module 151 computes a set of project scenarios that represent changes one could make to a home (parcel+structures on the parcel) and especially to specific rooms in a home. Each project scenario has: a unique identifier, metadata, such as a human-readable name, a human-readable description, one or more images representing the target state of the home post-change, and national and/or locally adjusted average costs and cost ranges to implement the scenario. Optional inputs include a numerical input with a default value, and high and low ends of the numeric range (e.g., for a kitchen remodel, a numeric input could be the size in linear feet of countertop). The default value can be derived from another known feature about the parcel (e.g., a second-floor addition could have a size that defaults to a percentage of the first-floor size in square feet).

The remodel module 151 also uses a categorical input with a default value and an enumeration of accepted values (e.g., for a kitchen remodel, a categorical input could be the countertop material, with a default of granite, and accepted values including butcherblock, composite, marble, etc.). The remodel module 151 also uses a Boolean input of true or false—with a default value (e.g., for a kitchen remodel, a Boolean input could represent whether the remodel should include an island). Configurable rules describe an alteration to the baseline attributes of a parcel. A numerical alteration is a formula representing a mathematical operation to an attribute where the attribute represents a quantity of something (e.g., add one to bedroom_count, or multiply the size of the deck by 2). A categorical alteration is an articulation of a change to a categorical value (e.g., change flooring_type from carpet to hardwood). A Boolean alteration is an articulation of a change to a Boolean value (e.g., change has_master_bath from false to true). The rules can be configured with logical operations and combination of the above (e.g., if (has_master_bath is false) then {set has_master_bath=true; set baths_count=baths_count+1: set bathrooms_condition=“luxury_grade”). There is an enumeration of eligibility criteria for the scenario (for example, most townhomes would be ineligible for a top-story addition). Eligibility can be based on one or more intrinsic attributes of the baseline parcel, including parcel type (e.g., townhome), amenities (quantity of bedrooms, condition of a specific room, size of an individual story), location. Comparisons may be used to aggregate statistics about a collection of parcels, typically homes of a similar type that are in close geographic proximity to the subject parcel (e.g., this home is eligible for an Accessory Dwelling Unit (ADU) if greater than 5% of similar homes nearby have an ADU). There is an enumeration of one or more parent categories to which the scenario belongs (example: Add a deck and Build a patio both belong to the category “Exterior”).

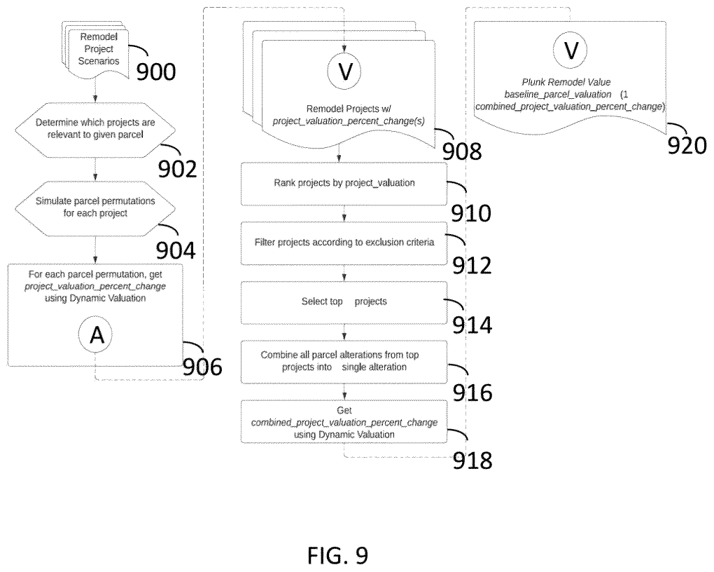

The next operation of FIG. 9 is to determine which projects are relevant to a given parcel 902. The remodel module 151 iterates through all possible project scenarios, evaluating the baseline parcel attributes against each scenario's eligibility criteria, excluding scenarios that do not meet the eligibility criteria. The resulting list of eligible projects is subject to an algorithmic simulation of parcel permutations for each project. The system evaluates each of the scenario's alteration rules, in order, against the baseline attributes of the parcel, to derive a new “altered” permutation of the parcel's attributes. The full set of parcel permutations is then processed to get project valuations based upon a dynamic valuation. That is, each parcel permutation is scored through the Dynamic Valuation Process (callout “A”, an input to the process represented by steps in FIG. 5, which produces a dynamic value labeled as callout “V”. This process accepts a batch of scenarios, including baseline and multiple “altered” permutations of attributes for a parcel. The process returns the dollar amount and percent change between the baseline and each of the permutations. For example, a baseline parcel 1234 with a bedroom count of 3 is worth $200,00. A permutation of parcel 1234 has a bedroom count of 4 and is worth $220,000, an increase of 10%. The scoring can be done “online” through an API call—each versioned model is exposed through a service with a RESTful API endpoint, and can be called by a downstream first-party or third-party application in real-time. In an offline mode, a batch process is executed across a configurable list of one or more parcels.

The remodel module 151 collects the set of outputs from running the DVM 520 on the set of parcel permutations, annotating each project scenario with its valuation_change 908. The set of projects is grouped by category and then sorted in decreasing order by each project's valuation_change 910. The most valuable project is first and the least valuable project is last.

Projects are then filtered based upon exclusion criteria 912. For the purposes of recommending a set of projects that a homeowner or investor should consider, certain projects that belong to the same category have been labeled as mutually exclusive. A filtering algorithm is applied to ensure that only the project in each category with the highest value_change will be recommended. This prevents unreasonable scenarios from occurring, such as recommending converting a garage to a bedroom and adding a garage.

Next, the top projects are recommended 914. A configurable number of projects can be recommended. In one embodiment, the top 5 projects are recommended, but this could vary by any number of measures or dimensions (e.g., townhomes could have Top 3, homes in a specific zip code could have Top 7, or a customer's application could request the Top N, where N is specified by the customer). The system annotates the Top N projects as “Recommended”. Projects with negative valuation changes are not recommended. Due to this, and the application of eligibility and exclusion filtering, it is possible for the final list of recommended projects to be fewer than N.

Valuation of real estate represents a combination of many, often non-linear effects. For example, there is a point in which adding bedrooms provides diminishing returns. Specific to this step, the combined valuation impact of making multiple changes to a parcel is often less than the sum of the impacts of the individual changes. To deal with this, the system aggregates all parcel attribute alterations from the combined set of recommended projects permutations 916. The system then re-scores this combined “uber” project to get the expected valuation increase if all recommended projects were to be completed 518.

As a result of scoring the final, combined “uber” Project, a total valuation_change can then be applied to the baseline valuation of the subject parcel 920. For example, completing the Top N projects increases the value of the parcel by 20%, the parcel is currently estimated to be valued at $500,000, then the remodel value is $500,000+20%, or $600,000, with $100,000 in “upside value”.

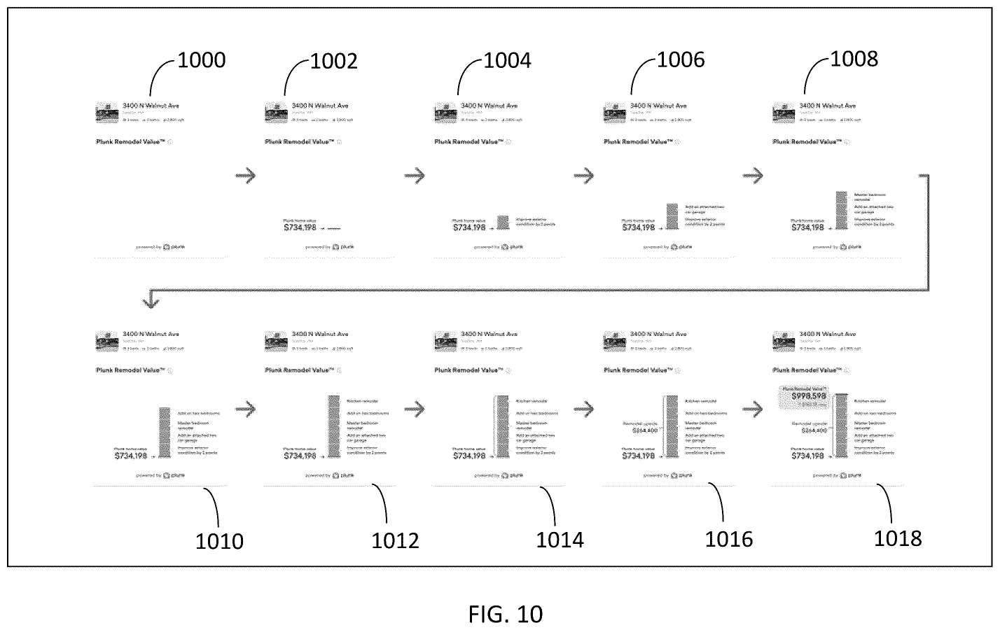

The results of these operations may be rendered by the visualization module 154 and sent to the client device 102 for display. The visualization module 154 may produce the graphical user interfaces of FIG. 10. Interface 1000 is a landing page for a specified address. Interface 1002 shows a dynamically computed value for the specified address. As the operations of FIG. 9) are performed, additional input is displayed. Interface 1004 makes a recommendation to improve the exterior, interface 1006 makes a recommendation to add an attached two car garage. Interface 1008 recommends a master bedroom remodel, while interface 1010 recommends the addition of two bedrooms. Interface 1012 recommends a kitchen remodel. Interface 1014 shows that the five recommendations are now combined into a group. Interface 1016 specifies a specific remodel upside for the five projects. Interface 1018 shows the new total value of the property if all the projects are completed. The visual indicia associated with the textual description of each project may be sized to characterize the value of each textually described project. In an embodiment of the invention, tapping the visual indicia results in the display of the dollar amount increase in value to the residence if the project is undertaken.

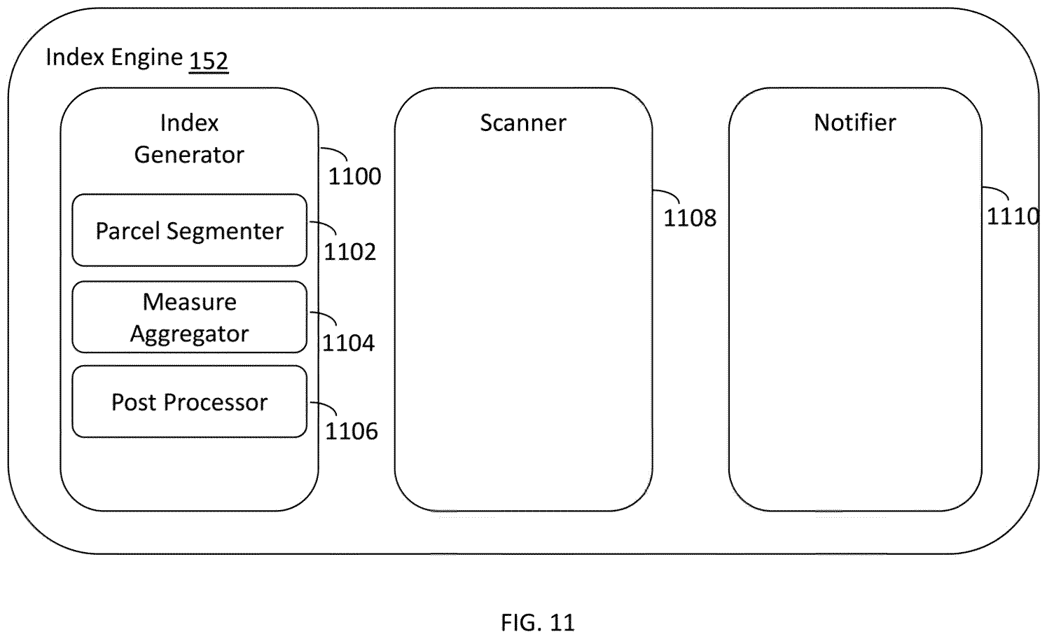

The analytics module 148 produces dynamic property values that can be aggregated in a variety of manners by the index engine 152. FIG. 11 illustrates an embodiment of the index engine 152. The index generator 1100 is a module for generating custom indexes. Each index represents a valuation-related dynamic in real estate. Each index is a normalized aggregation of a valuation-related measure, applied to a custom-defined set of parcels. The index engine 152 supports multiple, pre-built measures, and allows additional measures to be defined. Pre-built measures include but are not limited to: total absolute dollar value for the set of parcels, median or mean dollar value for the set of parcels, and median or mean dollar value per square foot for the set of parcels.

A parcel segmenter sub-module 1102 creates one or more custom groupings of parcels, based on configurable segmentation inclusion and exclusion criteria, such as: a specified set of addresses or property identifiers (e.g., County FIPS and Assessor Parcel Number (APN)), a specified set of geographies, one or more Metropolitan Statistical Areas (MSAs), one or more counties, one or more zip codes, a specified set of points and corresponding radius distances in miles/km: e.g., all parcels within a 10-mile radius from the centers of New York, Boston, Chicago and San Francisco, a specified set of parcel attributes, absolute amounts—e.g., all homes with 3 bedrooms, relative amounts—e.g., all home whose sizes are larger than the median size for the area. This can require application of the measure aggregator submodule 704 to pre-aggregate parcel measures, for example, to compute the median size of all parcels.

A grouping may be based on a specified set of valuation or transaction attributes. For example, estimated value bands may be specified (this requires invoking the measure aggregator 1104, which in turn invokes the dynamic valuation model.

A grouping may be based on transaction volume (e.g., parcels that have transacted more than once in the last year, or areas with at least 10,000 transactions in the last month) or by transaction recency (e.g., parcels that transacted in the last 12 months).

The index generator 1100 may be used to specify a set of nested hierarchies with two or more levels, e.g.:

```
  • By Geography:
    • All U.S. >
      • MSA 1 >
        • Zip Codes
      • MSA 2 >
        • Zip codes
      • ...
  • By Price Tier:
    • All U.S. >
      • 95^{th} Percentile by Price-per-square-foot
      • 50^{th} to 95^{th} Percentile by Price-per-square-foot
      • 10^{th} to 50^{th} Percentile by Price-per-square-foot
      • 0^{th} to 10^{th} Percentile by Price-per-square-foot
• A combination of the above
```

The measure aggregator submodule 704 numerically aggregates a defined set of measures. This is invoked to compute the index measure for the defined parcel segments. This can be optionally invoked as pre-processing to compute statistics about parcels for an entire set of geographies (e.g., compute the median value of all homes in a zip code). These statistics can then be referenced when defining parcel segments. If a measure is a numerical signal like the estimated value or the price-per-square-foot of a parcel, then an aggregation is an expression of how to numerically combine these individual measures for a grouping of parcels. For example, the median price-per-square-foot for a set of parcels. In one embodiment, the measure aggregator 1104 takes in the following inputs: set of parcels from the parcel segmenter 1102, a time range specified through a start and end time stamp, and a time resolution specifying the size of a time window over which to apply the aggregation: for example, hourly, daily, weekly, monthly, yearly.

The measure aggregator module 1104 can query or invoke other processes to retrieve the raw time series measure for each parcel. For example, it can invoke the dynamic valuation model to estimate the value of a parcel at specified intervals in the provided time range. Aggregation methods are pre-built (e.g., median or mean) or custom aggregation functions. The measure aggregator 704 returns: a time series representing the aggregation applied to the measure, at the specified time resolution, over the specified time range.

A Post-Processor module 1106 refines the aggregated measure, typically to normalize it to a point in time (e.g., an index value of 100 might represent the total value of all residential real estate on Jan. 1, 1980); and/or a configurable index unit (e.g., an index unit value of 100 might represent $250 per square foot). Optional, configurable post-processing of the measure can be further applied, to convert the representation of the measure, for example, from an absolute value to a percent change, to apply a smoothing algorithm to remove volatility, to re-aggregate time resolutions from a higher to a lower granularity (e.g., daily to monthly), to compute a first- or second-order derivative of the time series (i.e., rate of change or acceleration of the index measure).

A scanner module 1108 of the index engine 152 monitors time series signals, including: index measures generated by the index generator 1100. The scanner module 1108 optionally provides external time series data (e.g., stock prices) and continuously compares changes in the time-series signals, identifying the top positively and negatively correlated signals and their associated lags with any set of indices generated by the index generator 1100. The scanner module 1108 produces correlation matrices that are continuously published as update events via API, where the insights they contain can be viewed and either manually or programmatically acted on downstream.

A notifier module 1110 is one such downstream system. The notifier module 1110 accepts a configurable set of scenarios to monitor, monitors the update events published by the scanner 1108 via API, filters out events that do not match the requisite scenarios and republishes events that match the requisite scenarios. This allows downstream applications to programmatically act on important changes in index signals, for example, algorithmic trading of assets with a high degree of exposure to real estate and alerting of portfolio managers who oversee blocks of investment properties.

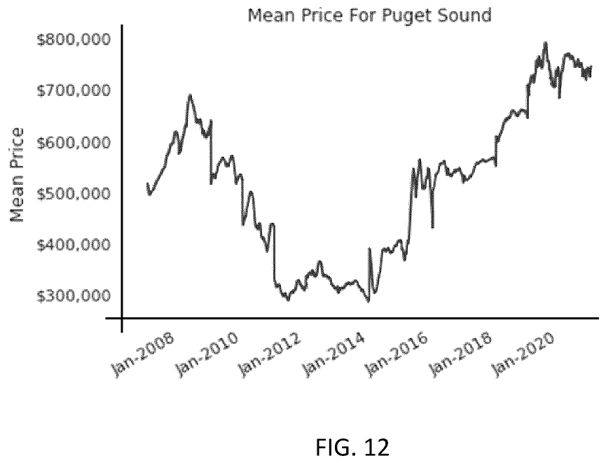

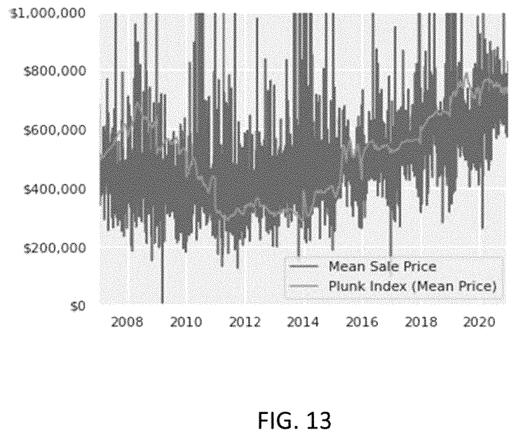

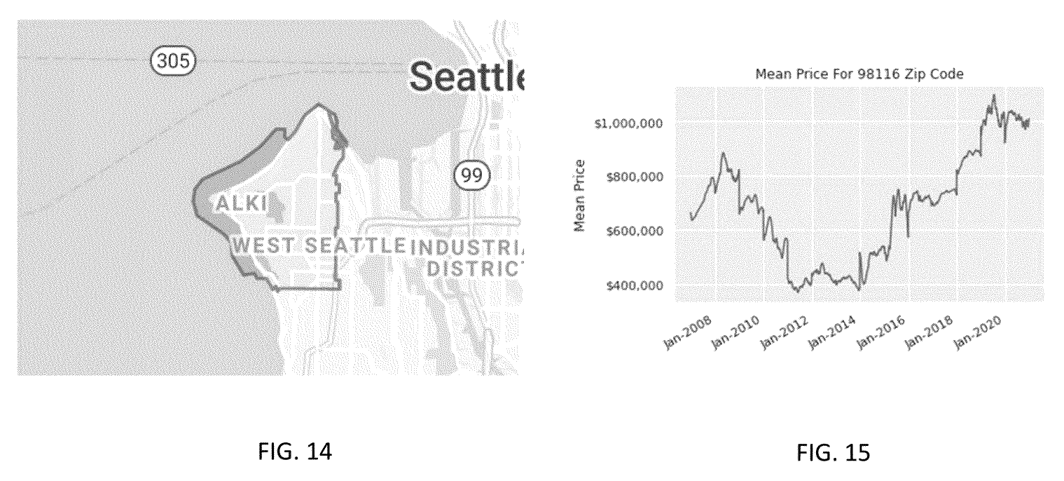

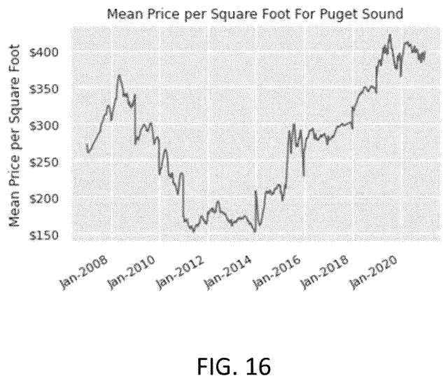

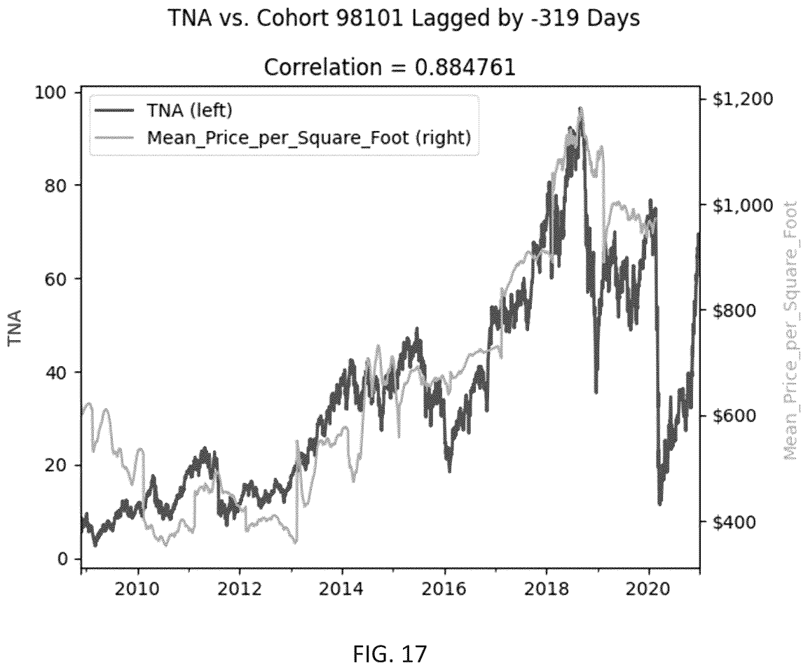

The index engine 152 operating with the visualization module 154 can provide visualizations of various residential real estate indices. For example, FIG. 12 illustrates a mean price for a geographic region on an annual basis. FIG. 13 illustrates superimposed graphs generated by the post processor 1106. FIG. 14 illustrates a neighborhood constructed by the parcel segmenter 1102. FIG. 15 illustrates a mean price index for the neighborhood, which was produced by the measure aggregator 1104. FIG. 16 illustrates a different metric of dollar per square foot for a geographic region, as computed by the measure aggregator 1104. FIG. 17 illustrates a correlation graphic computed by the scanner 1108.

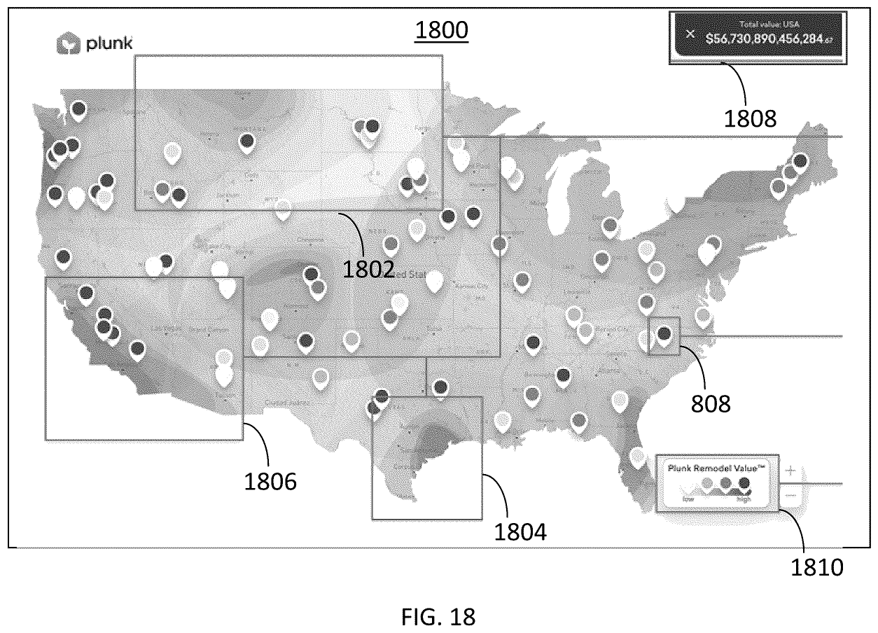

The groupings supplied by the index engine 152 allow the visualization module 154 to produce a variety of visualizations. FIG. 18 includes an interface 1800 with a map of the United States. A user at client device 102 has formed three geographical segments 1802, 1804 and 1806. A ticker block 1808 displays to total value of residential property in geographical segments 1802, 1804 and 1806. FIG. 18 represents a heat map of remodel values. The opacity of the heatmap represents the average remodel value against the median remodel value for the entire area within a segment. A darker color represents a higher remodel in relation to other areas in the segment. Block 808 shows a remodel value pin representing a specific home.

The dark opacity represents an anomaly home that does not follow the trend of the area. Block 1810 is a legend explaining the gradient and pin representations.

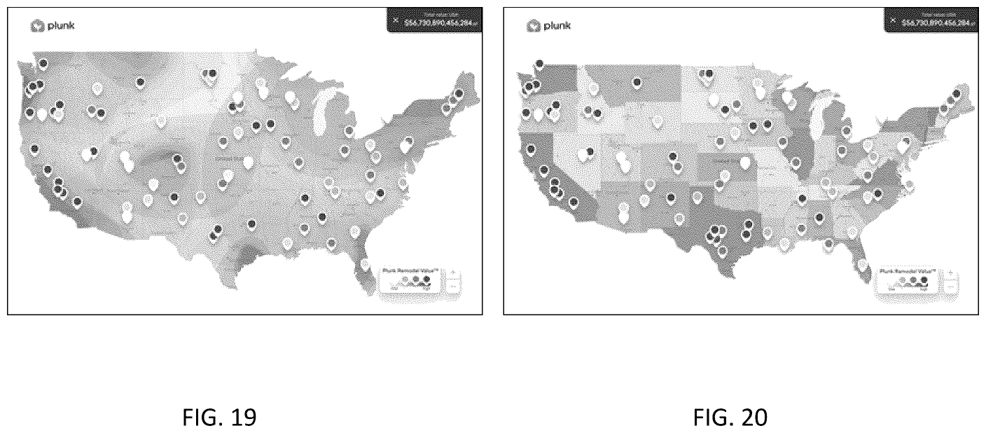

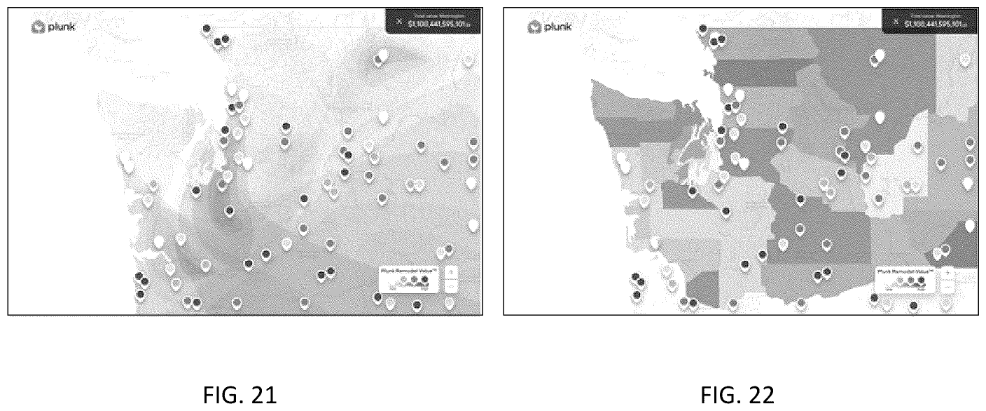

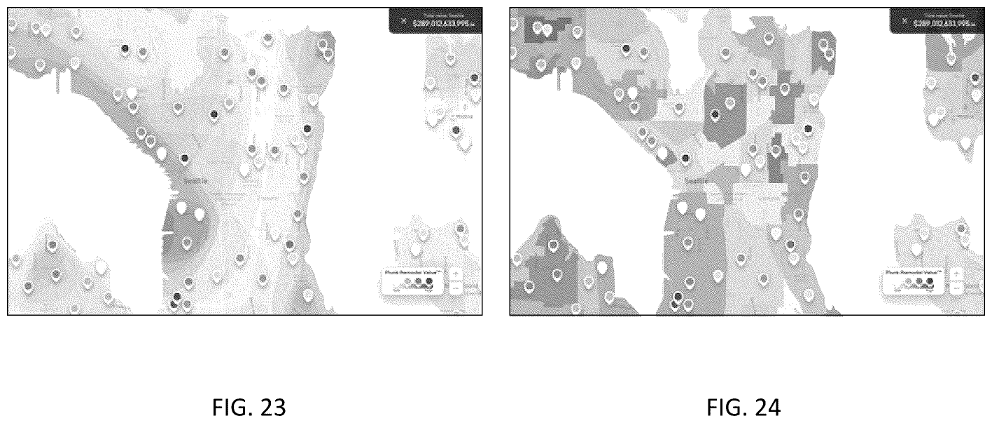

FIG. 19 is an interface showing smooth gradients for trends in particular areas. FIG. 20 sets state boundaries. FIG. 21 illustrates smooth gradients representing trends in particular areas. FIG. 22 specifies county boundaries. FIG. 23 shows gradients in different regions around Seattle. FIG. 24 illustrates neighborhood boundaries.

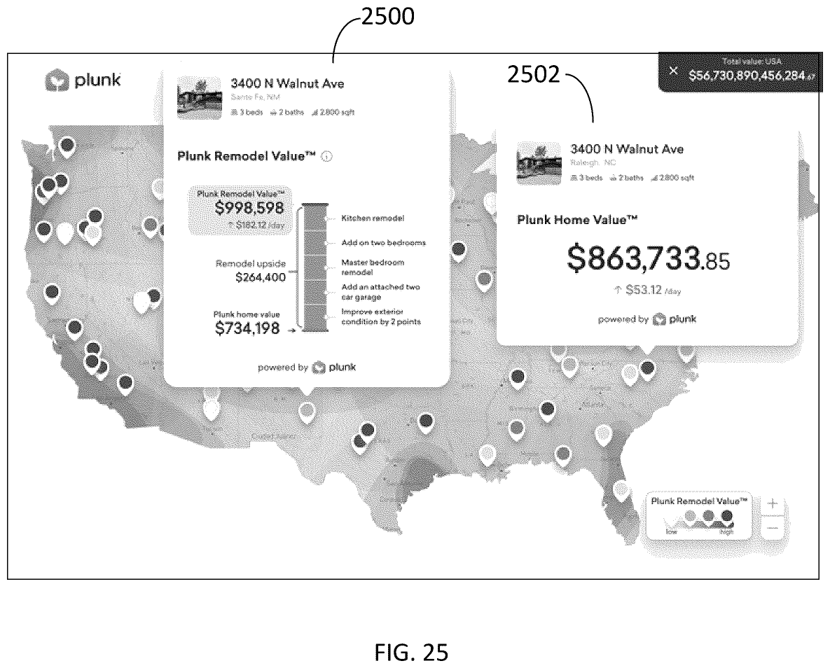

FIG. 25 illustrates an interface with detailed information 2500 on a selected home in one area of the country. The information includes a dynamically computed home value and information on possible remodel enhancements. Block 2502 includes information on a selected home in a different area of the country. In this example, the dynamically computed value of the home is displayed, as is the ML model-determined trending per day value change of the home (rate change). This constitutes a ticker display of home value for a single property, unlike the aggregate ticker display of block 1808 in FIG. 18. The ticker display is similar to an odometer as it is constantly changing with valuation changes.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape: optical media such as CD-ROMs, DVDs and holographic devices: magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
collecting multi-modal residential real estate data from networked machines:
segregating the multi-modal residential real estate data into relational data, textual data and image data to form segregated data:
correcting statistical anomalies in the segregated data to form first refined data:
augmenting the first refined data to reduce sparsity and form second refined data:
computing numerical embedding vectors from the second refined data:
aggregating the numerical embedding vectors by geographic region:
training a deep neural network using the numerical embedding vectors to form models for predicting residential real estate attributes:
utilizing the models to compute a dynamic value for a specified residential real estate asset:
defining parcels in a geographic area surrounding the specified residential real estate asset:
utilizing the models to compute dynamic values for the parcels in the geographic area; and
computing analytics for the parcels in the geographic area.

2. The computer implemented method of claim 1 wherein the analytics include a total absolute dollar value for the parcels in the geographic area.

3. The computer implemented method of claim 1 wherein the analytics include a median or mean dollar value for the parcels in the geographic area.

4. The computer implemented method of claim 1 wherein the analytics include a median or mean dollar value per square foot for the parcels in the geographic area.

5. The computer implemented method of claim 1 wherein the parcels are defined by a set of addresses.

6. The computer implemented method of claim 1 wherein the parcels are defined by a metropolitan statistical area.

7. The computer implemented method of claim 1 wherein the parcels are defined by one or more counties.

8. The computer implemented method of claim 1 wherein the parcels are defined by one or more zip codes.

9. The computer implemented method of claim 1 wherein the parcels are defined by a radius surrounding a center point.

10. The computer implemented method of claim 1 wherein the parcels are defined by common residential home attributes.

11. The computer implemented method of claim 1 wherein the parcels are defined by value bands.

12. The computer implemented method of claim 1 wherein the parcels are defined by transaction volume for a specified time period.

13. The computer implemented method of claim 1 wherein the parcels are defined by transactions within a specified time period.

14. The computer implemented method of claim 1 further comprising generating time series signals representing residential real estate trends.

15. The computer implemented method of claim 1 wherein supplying the dynamic values and the remodel suggestions includes supplying a map with different indicia representing relative value of remodel suggestions in a specified geographic region.

16. The computer implemented method of claim 15 wherein the specified geographic region is the United States.

17. The computer implemented method of claim 15 wherein the specified geographic region is a specified city.

18. The computer implemented method of claim 15 wherein the specified geographic region is a specified neighborhood.
